(19) United States
(12) Patent Application Publication
(10) Pub. No.: US 2022/0055797 A1
(43) Pub. Date: Feb. 24, 2022

(54) COLLAPSIBLE CONTAINER AND COMBINATION THEREOF

(71) Applicant: Free-Free Industrial Corp., Taipei (TW)

(72) Inventor: Sheng-Yu Liu, Taipei (TW)

(21) Appl. No.: 16/999,181

(22) Filed: Aug. 21, 2020

(51) Int. Cl. B65D 21/08; A01K 5/01

(52) U.S. Cl. CPC B65D 21/086; A01K 5/0114

(57) ABSTRACT

A collapsible container comprises a bottom plate, a first ring, a second ring, a spring, a cladding layer, and at least two fastening parts. The first ring is disposed around the bottom plate. The caliber of the second ring is smaller than that of the first ring. The two ends of the spring are respectively connected to the first ring and the second ring to maintain a distance between the first ring and the second ring. When the spring is compressed, the second ring can be moved and be stored in an inner side of the first ring. The cladding layer clads the bottom plate, the first ring, the second ring and the spring. The fastening parts are disposed symmetrically on an outer side of the first ring for fastening the second ring when the second ring is moved to the inside of the first ring.

### FIELD OF THE DISCLOSURE

The present invention relates to a container, and more particularly to a collapsible container suitable for pet feeding.

### BACKGROUND

Pets can bring many different pleasures to humans. In modern life, pets have become an indispensable family member. When pet owners travel or play with their pets, they need to feed their pets, such as water, dry dog food or cat food. For convenient carrying when going out, pet feeding appliances need to have the characteristics of convenient storage, good portability, and high safety.

Therefore, in the field of containers or appliances suitable for pet feeding, how to make pet feeding containers have the characteristics of fast collapsing, convenient carrying, high safety, simple manufacturing, and wide application range, has become one of the problems needed to be solved for those who skilled in the art.

### SUMMARY

The purpose of the present invention is to provide a collapsible container suitable for pet feeding and a combination thereof. The collapsible container has the advantages of simple manufacturing, fast collapsing, and small space occupation.

In order to achieve at least one of the advantages or other advantages, one embodiment of the present invention provides a collapsible container comprising: a bottom plate; a first ring, disposed around the bottom plate; a second ring, wherein a caliber of the second ring is smaller than a caliber of the first ring; a spring, wherein two ends of the spring are respectively connected to the first ring and the second ring to maintain a distance between the first ring and the second ring, when the spring is compressed, the second ring can be moved and stored in an inner side the first ring; a cladding layer, cladding the bottom plate, the first ring, the second ring and the spring to form a chamber; and at least two fastening parts, disposed symmetrically on an outer side of the first ring for fastening the second ring when the second ring is moved to the inside of the first ring.

In some embodiments, when only one the fastening part is used to fasten one side of the second ring, the other side of the second ring is lift up by the spring to form an inclined container by the first ring, the spring and the second ring. At this time, the height of the opening of the collapsible container can be adjusted so that the collapsible container has an inclined opening, and the capacity of the collapsible container can also be adjusted.

In some embodiments, the fastening parts are chosen from the group of quick fasteners, slide fasteners and snap structures. The touch fasteners or the hook and loop fasteners can be applied to serve as the quick fasteners.

In some embodiments, the cladding layer is made of waterproof and breathable fabric. By this way, liquid such as water or solid such as pet food can be placed in the chamber of the collapsible container. The cladding layer may be fixed on the first ring and the second ring by sewing, zippers or fasteners.

In some embodiments, the collapsible container further comprises an inner layer disposed inside the chamber. The upper portion of the inner layer is fixed on the side wall of the second ring by stitching. The collapsible container further comprises sleeves which are parts of the inner layer. One end of the spring extends along the inner walls of the second ring and penetrates through the sleeves for fixing the end of the spring on the inner walls of the second ring. The inner layer may be made of waterproof fabric, non-woven fabric, or nylon cloth. When the inner layer is a waterproof fabric, the collapsible container will not leak when liquids such as water are contained.

In some embodiments, the first ring and the second ring are made of plastic.

In some embodiments, the collapsible container further comprises sleeves disposed respectively on inner walls of the first ring and the second ring. The two ends of the spring respectively extend along the inner walls of the first ring and the second ring and penetrate through the sleeves for fixing the two ends of the spring on the inner walls of the first ring and the second ring.

In some embodiments, the front portions of the two ends of the spring are respectively sheathed with protective sheaths. The protective sheaths can be made of rubber material to prevent the front portions of the two ends of the spring from penetrating the cladding layer and hurting the pets or user's hand.

In some embodiments, the two ends of the spring respectively extend along and fixed on the inner walls of the first ring and the second ring.

In some embodiments, the diameter of the cross-section of the spring is 0.5 mm to 1 mm. This arrangement enables the spring to maintain a better elasticity in the collapsible container.

In some embodiments, the collapsible container further comprises a buckle disposed on the outside of the first ring. The buckle can be used for hanging or carrying the collapsible container after collapsing.

To achieve at least one of the advantages or other advantages, one embodiment of the present invention further provides a combination of collapsible container comprising at least two the collapsible containers as above. The two collapsible containers have different calibers, the caliber of the first ring of the collapsible container with smaller caliber is smaller than the caliber of the second ring of the collapsible container with larger caliber, thereby the collapsible container with smaller caliber may be inserted and stored completely in the collapsible container with larger caliber.

In some embodiments, the combination of collapsible container further comprises a connecting part for connecting respectively the two collapsible containers having different calibers to prevent the two collapsible containers with different calibers from being separated from each other. Therefore, the storage space occupied by a plurality of collapsible containers of different calibers can be decreased.

Accordingly, the collapsible container and the combination thereof provided by the present invention have the advantages of simple manufacture, fast storage, and small space occupation. When feeding pets while traveling, it is convenient and quick to use the collapsible container for putting food and drink separately.

The foregoing description is merely an overview of the technical solution of the present invention. In order to enable a clearer understanding of the technical means of the present invention, and thus it can be implemented in accordance with the teachings of the present invention, and to enable the above features and advantages of the present invention to be more clearly understood, the embodiments are described in detail with reference to the accompanying drawings.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a schematic diagram of an embodiment of the collapsible container in the present invention;

FIG. 2 is a side view of the embodiment shown in FIG. 1 in the present invention;

FIG. 3 is a schematic diagram of an embodiment of the spring of the collapsible container in the present invention;

FIG. 4 is a schematic diagram of another embodiment of the spring of the collapsible container in the present invention;

FIG. 5 is a perspective view of the collapsible container in the present invention after the cladding layer is removed;

FIG. 6 is a schematic diagram of another embodiment of the collapsible container in the present invention;

FIG. 7 is a perspective view of the embodiment shown in FIG. 6 in the present invention;

FIG. 8 is a schematic diagram of the collapsible container in the collapsed state in the present invention;

FIG. 9 is a side perspective view of the embodiment shown in 8 in the present invention;

FIG. 10 is a schematic diagram of another embodiment when the collapsible container is collapsed in the present invention;

FIG. 11 is a schematic diagram of the combination of collapsible container in the using state in the present invention;

FIG. 12 is the schematic diagram of the combination of collapsible container in the collapsed state in the present invention.

### DETAILED DESCRIPTION OF PREFERRED EMBODIMENTS

It should be noted, the embodiments illustrated herein are applied for explaining rather than limiting the present invention.

The specific structural and functional details disclosed herein are only representative and are intended for describing exemplary embodiments of the disclosure. However, the disclosure can be embodied in many forms of substitution and should not be interpreted as merely limited to the embodiments described herein.

In the description of the present invention, the terms for indicating orientations or positional relationships such as “center”, “longitudinal direction”, “above”, “below”, “left”, “right”, “vertical”, “horizontal”, “top”, “bottom”, “inside” and “outward” for indicating orientations or positional relationships refer to orientations or positional relationships as shown in the drawings; the terms are for the purpose of illustrating the disclosure and simplifying the description rather than indicating or implying the device or element must have a certain orientation and be structured or operated by the certain orientation, and therefore cannot be regarded as limitation with respect to the disclosure. In addition, the terms as “first” and “second” are used for describing purpose and cannot be interpreted as the instruction or hint about the importance nor be implied the quantity of characteristic elements. Thus, the feature limited with “first” or “second” may include one or more characteristic element. In description of the present invention, the implication of “multiple” is two or more unless otherwise indicated. Further, the terms “comprises,” “comprising,” or any other variation thereof, are intended to cover a non-exclusive inclusion.

In this invention, unless otherwise clearly defined and limited, the terms such as “installation”, “being connected” and “connection” should be interpreted broadly, such as, can be fixedly connected with, also can be removably connected, or connected in one piece; and can be mechanically connected, also can be electrically connected; can be directly connected, also can be indirectly connected; can be connected by intermedia; can be the connection of two element internally. For the ordinary skilled in the art, the actual meaning of above-mentioned term in the present invention can be understood according to the specific situations.

The terms used herein are only for describing specific embodiments and are not intended to limit the exemplary embodiments. Unless the context clearly dictates otherwise, the singular forms such as “a” and “one” used herein are also intended to include the plural. It should also be understood that the terms “including” and/or “comprising” used herein specify the existence of the stated features, integers, steps, operations, units and/or components, and do not exclude the existence or addition of one or more other features, integers, steps, operations, units, components, and/or combinations thereof.

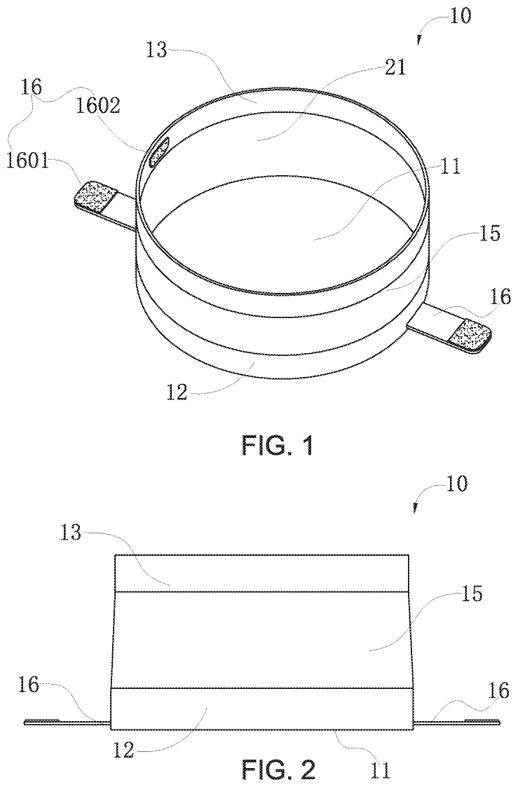

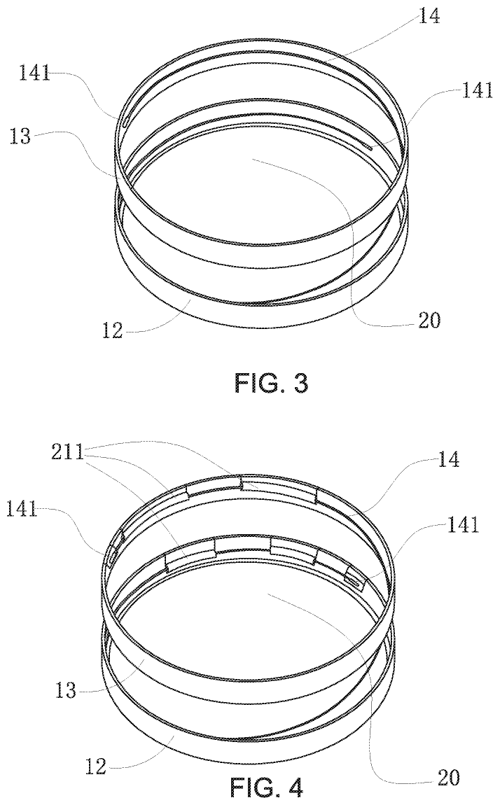

Please refer to FIG. 1 to FIG. 3. FIG. 1 and FIG. 2 are the schematic view and side view of the collapsible container 10 of the present invention, respectively. FIG. 3 is the schematic view of the collapsible container 10 after removing the cladding layer. In order to achieve at least one of the advantages or other advantages, an embodiment of the present invention provides a collapsible container 10, which comprises a bottom plate 11, a first ring 12, a second ring 13, a spring 14, a cladding layer 15 and at least two fastening parts 16. The bottom plate 11 is made of hard material, such as plastic, and has a certain degree of stability. The material of the first ring 12 and the second ring 13 may be plastic. The first ring 12 is disposed on the periphery of and around the bottom plate 11. Two ends of the spring 14 are respectively connected to the first ring 12 and the second ring 13 to maintain a distance between the first ring 12 and the second ring 13. When the spring 14 is compressed, the second ring 13 can be moved and stored in the inner side of the first ring 12. The cladding layer 15 clads the bottom plate 11, the first ring 12, the second ring 13 and the spring 14 to form a chamber 20. The at least two fastening parts 16 are symmetrically disposed on the outer side of the first ring 12. When the second ring 13 moves to the inner side of the first ring 12, the at least two fastening parts 16 are used to fasten and fix the second ring 13.

In an embodiment, the cladding layer 15 of the collapsible container 10 is made of waterproof and breathable fabric, which can make the chamber 20 have good air permeability, keep it dry, and prevent abnormal smell after use. In this way, liquid such as water or solid such as pet food can be placed in the chamber 20. The cladding layer 15 may be fixed on the first ring 12 and the second ring 13 by sewing, zippers or fasteners.

The caliber of the second ring 13 is smaller than the caliber of the first ring 12. According to actual usage requirements, the difference between the caliber of the second ring 13 and that of the first ring 12 in the collapsible container 10 may be adjusted in a range. In one embodiment, the caliber of the second ring 13 and the caliber of the first ring 12 have a relatively small difference, so that when the collapsible container 10 is expanded and used, its appearance looks like a cylindrical shape, as shown in FIG. 2. On the contrary, if the caliber of the second ring 13 and the caliber of the first ring 12 have a large difference in value, the collapsible container 10 would look like a conical shape as a whole when it is expanded and used. Since the first ring 12 at the bottom has a larger caliber than the second ring 13 at the top, the collapsible container 10 has better stability during use and is not easy to tip or turn over.

The fastening parts 16 in the collapsible container 10 may be chosen from the group of quick fasteners, slide fasteners and snap structures. In one embodiment, when the fastener parts 16 are quick fasteners, the touch fasteners or the hook and loop fasteners can be applied. As shown in FIG. 1, when the fastener parts 16 are the touch fasteners or the hook and loop fasteners, the fastener parts 16 include a long strip of tape 1601 and a corresponding receiving part 1602. One end of the long strip of tape 1601 is connected to the cladding layer 15 outside the first ring 12, and the other end is provided with hook or loop structures, which is applied to connect to the receiving part 1602 disposed on the cladding layer 15 inside the second ring 13, thereby to fix the collapsible container 10 after being collapsed.

As shown in FIG. 3, in one embodiment, the front portions of two ends of the spring 14 in the collapsible container 10 are respectively sheathed with protective sheaths 141. The protective sheaths 141 can be made of rubber material to prevent the front portions of the two ends of the spring 14 from penetrating the cladding layer 15 and hurting the pets or user's hand.

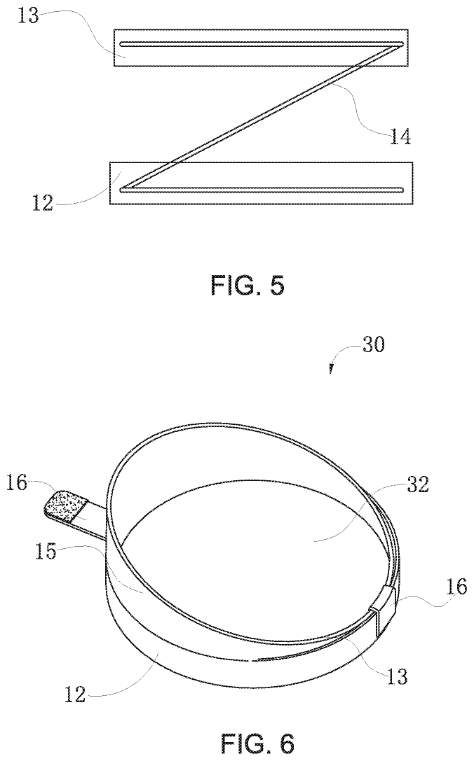

In an embodiment, the two ends of the spring 14 respectively extend along the inner walls of the first ring 12 and the second ring 13 and are fixed on the inner walls of the first ring 12 and the second ring 13. Thereby, the contact area between the spring 14 and the first ring 12 and the second ring 13 can be increased to provide sufficient expansion force between the first ring 12 and the second ring 13, and the distance between the first ring 12 and the second ring 13 can be maintained to prevent the opening of the container from being loose when the collapsible container 10 is used. Please also refer to FIG. 5, which shows a side perspective view of the collapsible container 10 after the cladding layer 15 is removed. As shown in the figure, the spring 14 extending on the inner walls of the first ring 12 and the second ring 13 looks like a “Z”-shaped structure.

In one embodiment, as shown in FIG. 1, the cladding layer 15 of the collapsible container 10 clads the chamber 20 formed by the bottom plate 11, the first ring 12, the second ring 13 and the spring 14. An inner layer 21 is disposed inside the chamber 20. In one embodiment, the inner layer 21 is made of waterproof fabric, non-woven fabric or nylon cloth. When the inner layer 21 is a waterproof fabric, the collapsible container 10 will not leak when liquid such as water is contained.

In an embodiment, sleeves 211 are respectively disposed on the inner walls of the first ring 12 and the second ring 13, and the two ends of the spring 14 extend along the inner walls of the first ring 12 and the second ring 13 respectively and penetrate through the sleeves 211 for fixing the two ends of the spring 14 on the inner walls of the first ring 12 and the second ring 13. In one embodiment, the sleeves 211 are a part of the inner layer 21 and is fixed on the side walls of the first ring 12 and the second ring 13 by stitching. It is noted that only the sleeves 211 are shown in FIG. 4 and the other parts of the inner layer 21 are not shown.

In an embodiment, the diameter of the cross-section of the spring 14 is 0.5 mm to 1 mm. This arrangement enables the spring 14 to maintain a better elasticity in the collapsible container 10 for providing sufficient supporting force between the first ring 12 and the second ring 13, however it also gives the consideration of no need to take too much effort for user to press the second ring 13 for receiving.

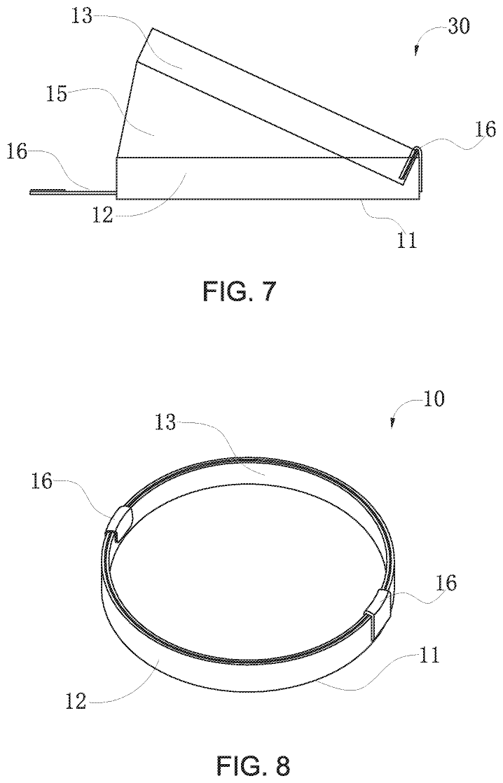

Please refer to FIG. 6 and FIG. 7, in an embodiment, when only one fastening part 16 of the collapsible container 10 is used to fasten one side of the second ring 13, the other side of the second ring 13 is still lift up by the spring 14 to form an inclined container 30 by the first ring 12, the spring 14 and the second ring 13 which are cladded by the cladding layer 15. That is, the opening of the container 30 will be inclined, which is convenient for smaller size of pets to eat. By using the fastening parts 16, the height of the opening of the collapsible container 10 can be adjusted to make the container opening incline, and at the same time, the volume of the collapsible container 10 can be adjusted.

In the embodiments shown in FIG. 6 and FIG. 7, the inclined container 30 is formed with a chamber 32. The volume of the chamber 32 is smaller than the volume of the chamber 20 in FIG. 3. That is, a smaller amount of pet food or water can be placed in the chamber 32 without overflow. At the same time, one side of the inclined container 30 with the fastening part 16 fastened to the second ring 13 is at a relatively low position, so the inclined container 30 can feed young pets. It is easy to operate the inclined container 30. For many pets, due to their relatively flat face, the design of the inclined opening makes pets easier to eat and drink, and it is less likely to stain the chin or fur of pets. In addition, the pet is usually lying on the ground to drink water after high-intensity exercise, at this time, the inclined container can allow the pet to drink water in a more comfortable posture.

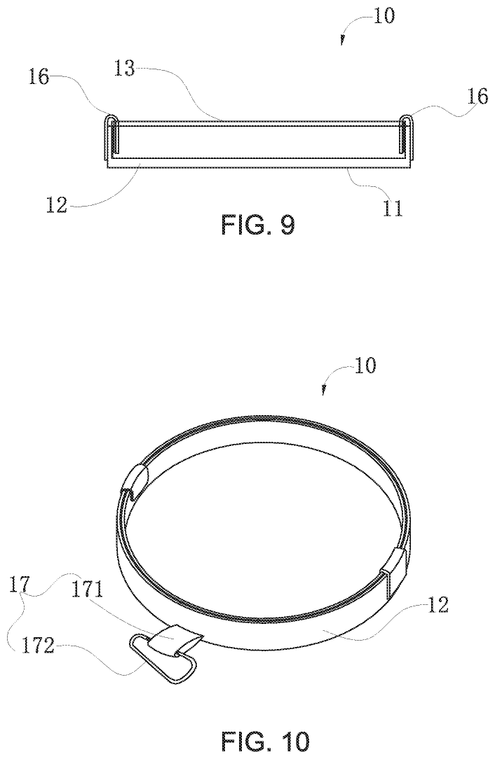

Please refer to FIG. 8 and FIG. 9, when the spring 14 is compressed, the second ring 13 can be moved and stored in the inner side of the first ring 12. At the same time, at least two fastening parts 16 can be used to fasten and fix the second ring 13 and the first ring 12 together. In other words, when the collapsible container 10 is not in use or after use, the user only needs to press down the second ring 13 to collapse the entire container 10 and use the fastening parts 16 to fix it. The collapsible container 10 after being collapsed occupies a small space, is not easy to spread, and is convenient for storage and carrying.

Please refer to FIG. 10, in one embodiment, a buckle 17 may be disposed on the outside of the first ring 12 of the collapsible container 10. The buckle 17 includes a hanging ear 171 connected to the outer side of the first ring 12 and a hook 172 disposed on the hanging ear 171. After the collapsible container 10 is collapsed, the buckle 17 can be used for hanging or carrying. In other words, when the user goes out, the collapsible container 10 can be collapsed and hung on a backpack, belt, or even a bicycle.

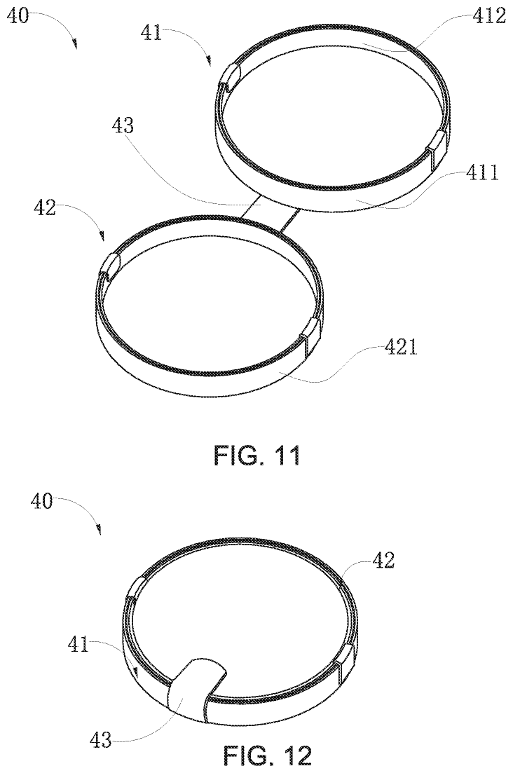

Please refer to FIG. 11 and FIG. 12, in order to achieve at least one of the advantages described above or other advantages, an embodiment of the present invention also provides a combination of collapsible container 40, which comprises at least two the collapsible containers 10. The two collapsible containers 10 have different calibers. The caliber of the first ring 421 of the collapsible container 42 with smaller caliber is smaller than that of the second ring 412 of the collapsible container 41 with larger caliber, so that the collapsible container 42 with smaller caliber may be stored completely in the collapsible container 41 with larger caliber, as shown in FIG. 12. After the collapsible containers 41 and 42 are collapsed separately, the openings of the collapsible containers 41 and 42 can be opposed to each other, and the collapsible container 42 can be stuffed into the opening of the collapsible container 41 to collapse the entire combination for storage. Thereby, it is convenient to store and place a plurality of collapsible containers 41 and 42 of different calibers stacked on top of each other for storage and transportation conveniently.

In an embodiment, the combination of collapsible container 40 further comprises a connecting part 43, which connects the two collapsible containers 41 and 42 of different calibers, respectively, to prevent the two collapsible containers 41 and 42 of different calibers from being separated from each other. It should be noted that the two ends of the connecting part 43 can be sewn, attached, or glued to the respective bottom surfaces of the collapsible containers 41 and 42 respectively. Detachable joining means can also be used, such as touch fastener, buckle, or Velcro, which are attached to the bottom surfaces of the collapsible containers 41 and 42 respectively. In this way, according to different needs for users, the connecting part 43 can be removed from the collapsible container 41 or 42, so that the collapsible containers 41 and 42 can be used separately. Furthermore, with the design of the combination of collapsible container 40, a plurality of collapsible containers of different calibers can be fitted together for storage, which greatly reduces the space occupied by the containers, and is beneficial for storage, transportation, and carrying.

Accordingly, a collapsible container and a combination thereof provided in the present invention have the advantages of simple manufacture, convenient storage, small occupied space, and easy portability. In addition, it is very convenient and quick to use when feeding pets while traveling. In the combination of collapsible container provided by the present invention, two collapsible containers can occupy only the space of one collapsible container after being collapsed. In addition, when the two collapsible containers are opened and used, they can place food and water or different foods respectively for pets. Obviously, this design can provide more convenience for users.

The foregoing contents are detailed description of the disclosure in conjunction with specific preferred embodiments and concrete embodiments of the disclosure are not limited to these descriptions. For the person skilled in the art of the disclosure, without departing from the concept of the disclosure, simple deductions or substitutions can be made and should be included in the protection scope of the application.

What is claimed is:

1. A collapsible container, comprising:
a bottom plate;
a first ring, disposed around the bottom plate;
a second ring, wherein a caliber of the second ring is smaller than a caliber of the first ring;
a spring, wherein two ends of the spring are respectively connected to the first ring and the second ring to maintain a distance between the first ring and the second ring, when the spring is compressed, the second ring can be moved and be stored in an inner side of the first ring;
a cladding layer, cladding the bottom plate, the first ring, the second ring and the spring to form a chamber; and
at least two fastening parts, disposed symmetrically on an outer side of the first ring for fastening the second ring when the second ring is moved to the inside of the first ring.

2. The collapsible container according to claim 1, when only one the fastening part is used to fasten one side of the second ring, the other side of the second ring is lift up by the spring to form an inclined container by the first ring, the spring and the second ring.

3. The collapsible container according to claim 2, wherein the fastening parts are chosen from the group of quick fasteners, slide fasteners and snap structures.

4. The collapsible container according to claim 1, wherein the cladding layer is made of waterproof and breathable fabric.

5. The collapsible container according to claim 1, further comprising an inner layer disposed inside the chamber, the inner layer being made of waterproof fabric, non-woven fabric or nylon cloth.

6. The collapsible container according to claim 1, further comprising sleeves disposed respectively on inner walls of the first ring and the second ring, wherein the two ends of the spring are respectively extending along the inner walls of the first ring and the second ring and penetrating through the sleeves for fixing the two ends of the spring on the inner walls of the first ring and the second ring.

7. The collapsible container according to claim 1, wherein front portions of the two ends of the spring are respectively sheathed with protective sheaths.

8. The collapsible container according to claim 1, wherein the first ring and the second ring are made of plastic.

9. The collapsible container according to claim 1, wherein a diameter of a cross-section of the spring is 0.5 mm to 1 mm.

10. The collapsible container according to claim 1, further comprising a buckle disposed on the outside of the first ring.

11. The collapsible container according to claim 1, wherein the cladding layer is fixed on the first ring and the second ring by sewing, zippers or fasteners.

12. A combination of collapsible container comprising at least two the collapsible containers according to claim 1, wherein the two collapsible containers have different calibers, the caliber of the first ring of the collapsible container with smaller caliber is smaller than the caliber of the second ring of the collapsible container with larger caliber, thereby the collapsible container with smaller caliber may be stored completely in the collapsible container with larger caliber.

13. The combination of collapsible container according to claim 12, further comprising a connecting part for connecting respectively the two collapsible containers having different calibers.
